(19) United States
(12) Patent Application Publication
(10) Pub. No.: US 2005/0103200 A1
(43) Pub. Date: May 19, 2005

(54) Apparatus and method for making coffee extract

(76) Inventor: Heikki Huik, Scherrerville, IN (US)

Correspondence Address: HEIKKI HUIK, 2371 DEERPATH DR. APT.308, SCHERERVILLE, IN, 46375, US

(21) Appl. No.: 10/713,478

(22) Filed: Nov. 15, 2003

(51) Int. Cl. A23F 3/00

(52) U.S. Cl. 99/279

(57) ABSTRACT

A process and apparatus for forming a concentrated coffee extract is disclosed for use in the home or office, and even in relatively smaller sized coffee shops.

### BACKGROUND OF THE INVENTION

1. Field of the Invention

The invention relates to a process and an apparatus for making a coffee concentrate, and more particularly to a consumer-level apparatus that can extract a liquid coffee concentrate from ground coffee that is stable at room temperature, yet can be made at home, the office, or in a restaurant.

2. Description of the Prior Art

From the early fifteenth century, until the early part of the twentieth century, drinkable coffee was made by combining whole coffee beans, and then later, ground coffee, with water and then boiling the combination into a drinkable brew. Later in the twentieth century, it was discovered that the taste of drinkable coffee could be vastly improved if the water was added to the coffee grounds after it was boiled. That later discovery was the start of presently known coffee brewing practices.

Today there are many processes and devices to brew drinkable coffee. The most popular coffee making processes are: electric drip; manual drip; percolator; French press; the vacuum method; and pot or cup steeping. All of these processes have one thing in common, they batch brew coffee for near-immediate consumption and whenever a fresh cup of coffee is desired, a new batch has to be brewed. The biggest downside of such batch brewing processes is that there is usually some amount of brewed coffee which is not consumed. The leftover coffee is typically discarded, leading to wasted coffee, as well as the added expense of buying replacement coffee grounds. This point is especially true in reputable coffee houses, where the brewed coffee is only kept for a maximum of twenty minutes because brewed coffee, when left continuously on a hot plate, becomes completely unpalatable in less than an hour.

From the technological aspect of brewing coffee, it has been found that the main culprits of flavor deterioration with drinkable coffee are oxidation, over heating, time of storage where coffee volatile flavors and aromatics are lost and even exposure to sunlight. Present coffee brewing technology has not been able to satisfactorily overcome the above-mentioned problems once a batch of coffee is brewed, especially on the consumer level such as home or office use, and in restaurants or coffee shops. However, there have been some attempts to address and overcome these problems, such as by Marion E Pinkley in U.S. Pat. No. 4,363,262, where the interior of a coffee storage container was retrofitted with a movable liquid-gas separation member to prevent oxidation and loss of coffee flavor and aromatic volatile of the brewed coffee, thereby extending coffee freshness for a full day. Another such device that attempted to prolong coffee freshness was that of Wayne B Stone Jr. in U.S. Pat. No. 3,974,758, where a percolation coffee brewer incorporated a movable follower to isolate the brewed coffee from air within the brewer. The movable follower was inserted within the brewer after the brewing cycle was completed and after the percolator tube and filter basket were removed. As the level of coffee moves downward in the percolator, the follower likewise moves downward, thus isolating the brewed coffee from the entrapped air so that one batch could stay fresh all throughout the day.

Despite these attempts to preserve coffee flavor and freshness after the coffee is brewed, not much has been done to address freshness and flavor prior to the brewing process. By that it is meant that consumers usually purchase pre-ground coffee in metal cans, and any of the coffee grounds that are not immediately used after the can is opened, are continuously exposed to oxygen in the entrapped air. The plastic lid supplied with each can cannot effectively prevent the oxidation of the fresh ground coffee after multiple openings of the can, as the lid will always entrap air, and hence oxygen, under the lid of the can.

Another cause of coffee flavor deterioration is traced to the primary process of roasting the coffee beans. When coffee beans are roasted, there is a formation of about 800 flavor compounds, as well as the generation of carbon dioxide gas that is entrapped within the coffee beans. Unfortunately, these flavor compounds have respective boiling points, with some being as low as 0° F., making it extremely difficult, if not impossible, to prevent the loss of many of the flavor compounds and aromatics during the brewing process. Fortunately however, it has been found that with many of the more critical flavor compounds, if the coffee brewing temperature is maintained below 210° F. for at least a short period of time, those compounds will not be compromised or completely destroyed.

Not much has been invented in equipment or brewing methods that would give the every day consumer a better alternative for brewing a fresh tasting cup of coffee than what has been described above. So far, the only proposal by the coffee industry has been the introduction of instant coffee marketed in granular form. However, it is clear to anyone who has ever tasted instant coffee, that the taste is not as good as freshly brewed coffee. Another similar drawback with instant coffee to that of canned coffee is the problem of the coffee going stale after the jar has been opened repeatedly. Presently, instant coffees are only manufactured by large coffee manufacturers, from brewed coffee extracts. Such processes have been described extensively by authors like Sivetz in the book “Coffee. Technology,” by Pintauro, in “Coffee Solubilization” and by R. J. Clark and R. Macrae in “Coffee.”

To avoid the problems associated with the coffee bean roasting and brewing processes, it would be ideal if the consumer could make a concentrated coffee extract, as a means for overcoming many of the above-mentioned problems. However, technical information and equipment available to consumers to brew coffee extracts in the home or office is currently very limited. For instance, only one consumer level extract brewing device and process has shown up in the authors patent search, that belonging to Hauslain; Richard in U.S. Pat. No. 4,983,412. In that disclosure, the coffee extract process requires the addition of hot water over roasted, ground coffee while it is mechanically stirred. It is claimed in this disclosure that rapid stirring causes the complete release of entrapped carbon dioxide gas from the grounds that would otherwise shorten the life of the coffee extract. However, the present author has not found any evidence that removal of carbon dioxide gas prolongs the coffee extract storage life. However, two obvious shortfalls of that device is the need for a mechanical stirrer and that a filtering system was not addressed, leading one to believe that this device was geared for use with only large scale consumers, manufacturers. Although liquid coffee extracts would be a better choice for the common coffee drinking consumer, coffee extraction processes and equipment have been fully developed on the industrial level only, and not on the consumer level. To date, there are only a few U.S. coffee manufacturers that produce and sell liquid coffee extract to consumers through a limited number of coffee shops, grocery stores, mail order houses, Internet outlets, and in some vending machines. However, the liquid coffee extract sold through those outlets is rather expensive and therefore not very popular with the general public. Thus, even though brewing a coffee extract would be the ideal solution to overcoming the flavor deterioration shortfalls of brewed coffee, the choices available to consumers are very limited as to processes and devices. For example, the Toddy Coffee Maker, is the only coffee extract brewing device known to the present author that is available to the everyday consumer. Unfortunately, this extract maker is a cold process that requires a steeping time of 8 to 12 hours, and utilizes equipment that is not very consumer friendly. Furthermore, the process itself is performed in an oxygen rich atmosphere, which as mentioned above, compromises the flavor of the final product. Moreover, the coffee extract yield of this process is relatively low, about 30 cups per pound of roasted ground coffee, requiring storage of the extract in a refrigerator to prevent premature spoilage. Anther brewing processes to mention, is developed by Gregory B Rayon Jr. in U.S. Pat. No. 5,637,343 which discloses a liquid coffee extract process and device that is performed at relatively low temperatures, 75° F. to 90° F. Disadvantageously, this type of process is a large batch process, not designed for the every day consumer, and is performed in open oxygen-rich atmospheres. The steeping time required to brew the coffee extract is 24 to 48 hours. It requires occasional stirring, whereby the extract has to be filtered through a 0.2 micron filter in order to remove bacteria and produce a sterile concentrate that supposedly can be stored at room temperature for a long period of time. However, closed storage containers are still required to store the extract.

### SUMMARY OF THE INVENTION

The present invention is comprised of a coffee extraction unit and process for making a batch of concentrated coffee extract. The unit includes a water heating means that is disposed within a dispensing vessel that retains a predetermined volume of water. The dispensing vessel has a drain orifice and a means for valving the orifice, whereby when the valving means is in an open position, heated water is allowed to drain through said orifice and into a coffee basket that retains a predetermined volume of ground coffee. The volume of ground coffee and water used in the process are held at a specific ratio in order to produce concentrated coffee extract. The dispensing vessel is superimposed on top of the coffee basket such that the heated water is dispensed from drain orifice and into the coffee basket at a rate of flow between 400 and 800 milliliters per minute, thereby thoroughly saturating the coffee grounds. The dispensing vessel also encloses the coffee basket from exposure to atmospheric air. The coffee basket is tightly received within an extraction vessel such that the saturated coffee grounds are allowed to steep within the heated water that passes through the coffee basket and collect at a bottom of the extraction vessel. The steeping is performed with hot water and within a relatively oxygen-free environment, thereby adding to the flavor of the finished extract and to its shelf storage life. The extract is filtered prior to being dispensed into a storage vessel.

The features and advantages of the invention will be further understood upon consideration of the following detailed description of the embodiments of the invention taken in conjunction with the drawings, in which:

### BRIEF DESCRIPTION OF THE DRAWINGS

FIG. 1 is a perspective view of an extraction unit of the present invention.

FIG. 2 is a partial exploded view of extraction unit shown in FIG. 1.

FIG. 3 is a side view of purchased heating element assembly.

FIG. 4 is the purchased heating element's electrical schematic shown in FIG. 3.

FIG. 5 is a perspective view of a hot water measuring and dispensing vessel of extraction unit with a heating element.

FIG. 6 is a perspective view of the check valve assembly in sectional circle 6 of FIG. 5, highlighting the assembly enlarged

FIG. 7 is the cross sectional side view of FIG. 5 showing the heating element assembly and the bimetal disk valve assembly mounted to the vessel, through sectional line 7-7.

FIG. 8 is a partial cross sectional view in sectional circle 8 of FIG. 7, highlighting a bimetal valve assembly enlarged.

FIG. 9 is a cross sectional view showing the water overflow system, and the diffuser plate mounted to the vessel, through sectional line 9-9 of FIG. 5

FIG. 10 is a perspective view of a diffuser plate 86 as shown in FIG. 9

FIG. 11 is the cross sectional view of diffuser plate 86 through sectional line 11-11 of FIG. 10

FIG. 12 is a perspective view highlighting the assembly of diffuser plate 86 to the bottom of hot water measuring and dispensing vessel shown in FIG. 9.

FIG. 13 is a perspective view of the screw machined part 66 and the details of the part.

FIG. 14 is a perspective view of a hot water measuring and dispensing vessel of extraction unit without a heating element and bimetal disk-valve assembly

FIG. 15 is a the cross sectional view of FIG. 14 taken along the line 15-15.

FIG. 16 is a perspective view of a coffee basket with a section removed to highlight a bottom filter element.

FIG. 17 is a perspective view of a coffee basket filter element shown as a separate member

FIG. 18 shows the perspective view of the extraction vessel with a section removed to show a spigot and a stop

FIG. 19 is a cross sectional view of extraction vessel FIG. 18, through sectional line 19-19, with coffee basket inserted.

FIG. 20 is perspective view of a base unit.

FIG. 21 is a perspective view of a float.

FIG. 22 is a cross sectional view of float of FIG. 21, through sectional line 22-22.

FIG. 23 is a perspective view of a extract storage container.

FIG. 24 is a cross sectional view of extraction storage container of FIG. 23, through sectional line 24-24 with float FIG. 21 inserted.

FIG. 25 is a perspective view of a coffee extract measuring device

FIG. 26 is a cross sectional view of coffee extract measuring device FIG. 25, through sectional line 26-26.

FIG. 27 is an exploded view detailing how a pair of coffee extract containers can be mounted under a kitchen cabinet.

FIG. 28 is a perspective view of an additional coffee can lid for use with the extract system of the present invention.

FIG. 29 is a cross sectional view of the additional lid shown in FIG. 28 inserted into a commercial metal ground coffee can.

### DETAILED DESCRIPTION OF A PREFERRED EMBODIMENT

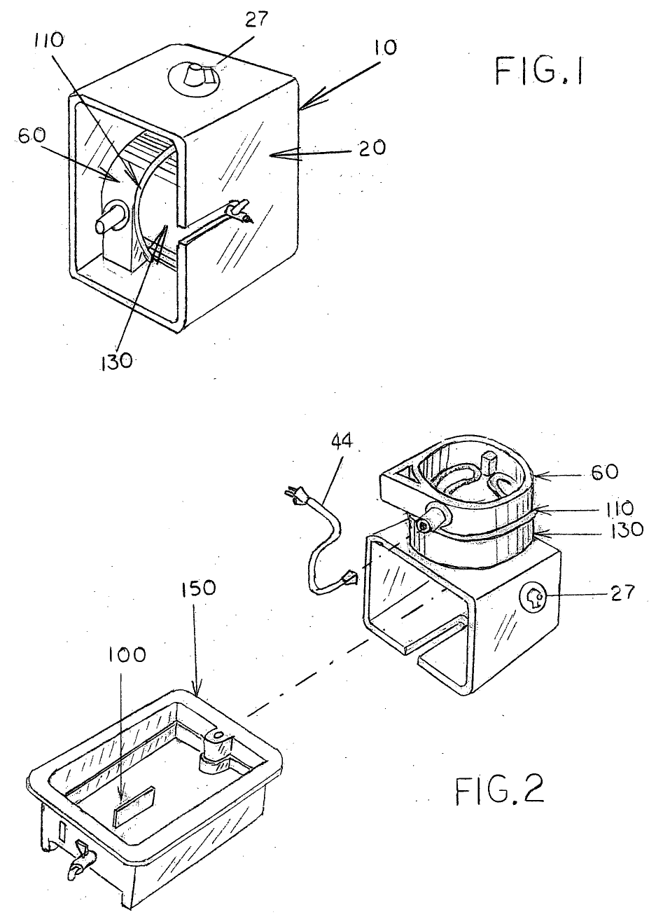

Referring to FIGS. 1 and 2, the coffee extraction unit of the present invention is shown as 10. It is envisioned that the present invention will comprise of two preferred embodiments where the unit boils its own water and a second embodiment where boiling water is added to the unit. The composition of the individual pieces that comprise the extraction unit will preferably be formed of injection molded plastic components in order to reduce manufacturing cost. Other materials such as glass, metals, ceramics or a combination of them can also be used. However, regardless of the final choice of materials, all must comply with FDA/ANSI. Standard 51. Each of the components, comprising the invention may be formed into any geometrical shape, round, square or rectangular, as long they share a matching shape. The preferred shape is round except for the base 20 that is square in shape, the hot water measuring vessel 60 that has one 90° protruding corner and the extraction storage container 150, that is rectangular in shape.

As FIG. 1 shows, extraction unit 10 is shown in a stored condition within one of the components base 20, and is further comprised of dispensing vessel 60, the coffee basket 110 that is shown inserted in the internal of the extraction vessel 130. Extract storage container 150, with a float 100 inserted, is also a component of extraction unit 10, as best shown in FIG. 2, but is not stored within base 20, as will become clearer later.

FIG. 2 is a partially exploded view showing all components removed from base 20 in order to highlight how base 20 functions to physically support and hold the components of the invention when coffee extract is being processed. In this illustration, it should be understood that the coffee extract formation generally takes place within the assembly of extraction vessel 130, coffee basket 110, and dispensing vessel 60. Although a detailed description of the extraction process will be provided later. An informal description will be provided immediately in order to facilitate an understanding of the assembly of the components comprising the invention.

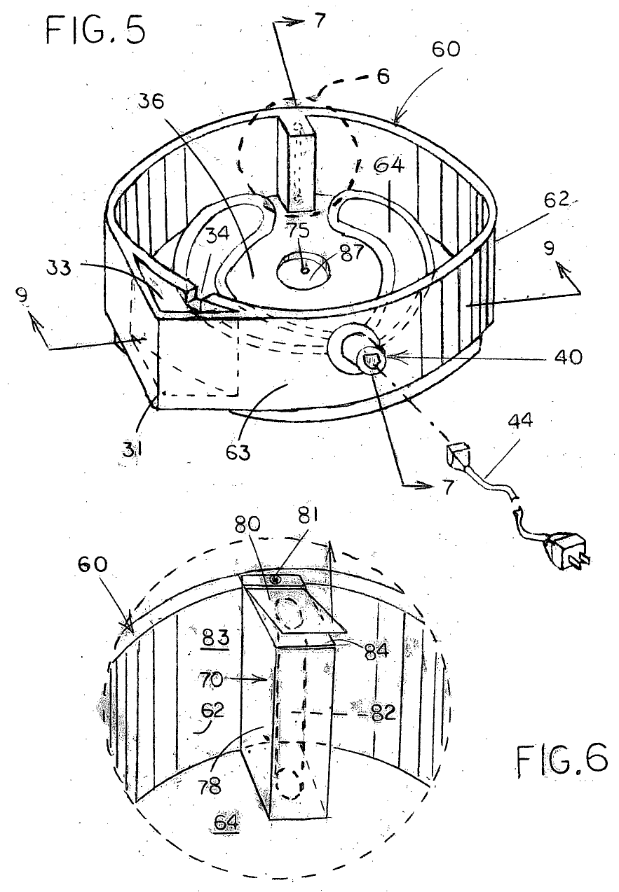

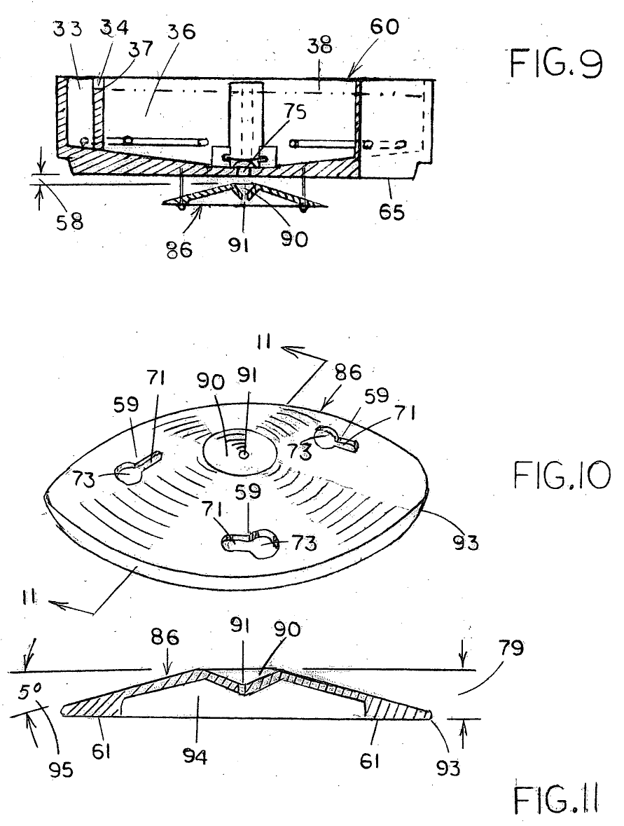

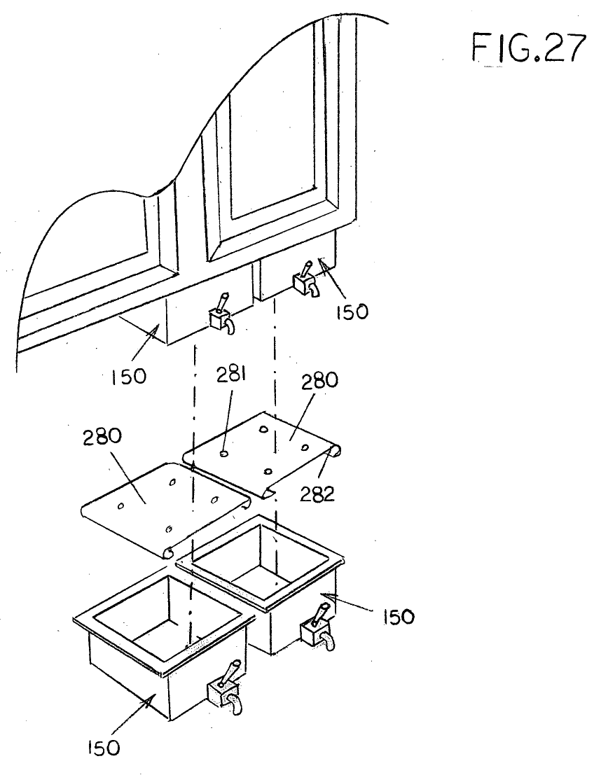

Essentially, the first step of the process is to add a predetermined amount of ground coffee into coffee basket 110, and insert basket 110 into the interior of extraction vessel 130. Dispensing vessel 60 is then superimposed onto coffee basket 110 and extraction vessel 130 assembly. Dispensing vessel 60 is then filled with cold water for the first preferred embodiments and boiled water for the second embodiment. The predetermined extraction water amount is controlled by filling extraction vessel 60 with water up to the bottom edge of an overflow opening provided, the cutout 34, in the side wall of vessel 60, as shown in FIGS. 5 and 9. With all two embodiments, dispensing vessel 60 will also include a valve means and an orifice (not shown in FIG. 2) to control the rate of water flow into coffee basket 110. With the preferred embodiment, where water is brought to a boil in the unit, the valve means will comprise of a bimetal disc valve assembly 50, FIG. 8, to release the heated water into coffee basket 110 once the water temperature reaches the predetermined temperature range, as will be explained in greater details later. In second embodiment, where boiled water is dispensed into vessel 60, the valve means is a removable stopper 108, FIG. 14 that will be removed to let the heated water to flow into coffee basket below After a predetermined steeping time period, the hot water and ground coffee combination will form the extract within extraction vessel 130. The extract is then drained from vessel 130 into extract storage container 150, which can be mounted to the underside of a cabinet for convenient storage and use, as illustrated in FIG. 27.

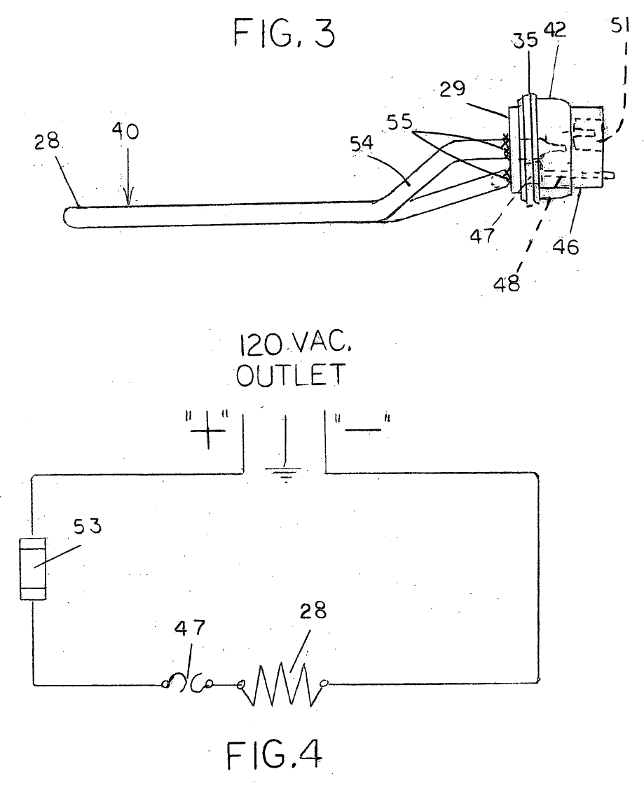

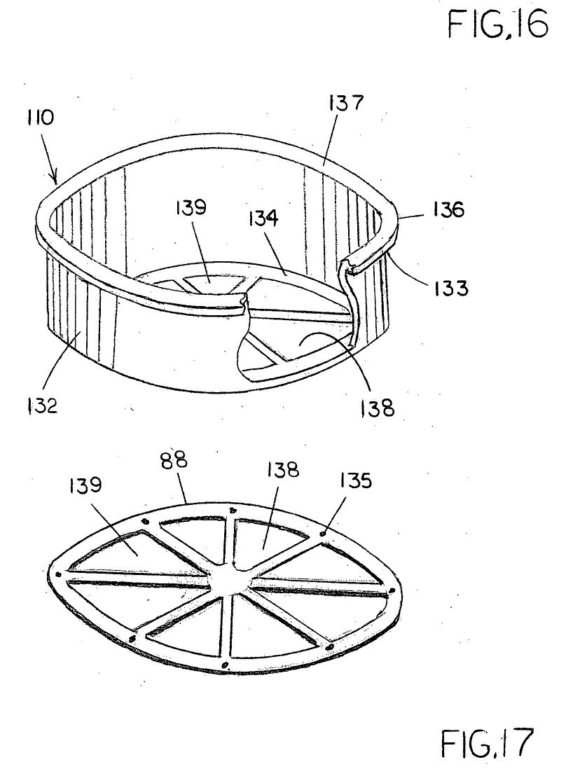

Before a detailed description of dispensing vessel 60 is provided, it should be understood that at least two different configurations are possible for vessel 60. Each configuration depending on whether water is brought to boil in vessel 60, or boiling temperature hot water is poured into vessel 60. The preferred type of dispensing vessel 60 uses a heating element assembly 40, FIG. 3, and bimetal disk-valve assembly 50, FIG. 8. The preferred type of dispensing vessel 60 is seen in FIGS. 3, 5, 6, 7, 8, 9, 10 11 and 12. The common and basic features of vessel 60, without heating element assembly 40 and bimetal disk check-valve assembly 50, will be used when practicing second embodiment, as seen in FIGS. 14 and 15 of the invention.

Heating element assembly 40 in FIG. 3, and schematic FIG. 4, is a purchased component, comprising of a cal-rod type tubular heater element 28, a flanged plate 29, a rubber washer 35, a plastic nut 42 (inside threaded), a plastic housing 46 that is threaded around the outer surface of the housing to receive the complimentary plastic nut 42, a manual reset thermostat 47, an extension rod 48, and a fuse 53, FIG. 4, for overload protection. Manual reset thermostat 47 is welded to the inner surface of flange plate 29. Extension rod 48 acts as a reset button and is attached to thermostat 47. Rod 48 extends out from plastic housing 46 and enable the user to reset thermostat 47 to start a new extraction cycle. Heating element assembly 40 has a tubular cover 54 that is braze around its perimeter to flanged plate 29 as shown at 55.

Heating element assembly 40 functions as follows: When flange plate 29 reaches the predetermined dry boil temperature, thermostat 47 opens and cuts off the flow of electricity to heater element 28. To start the current flow again for a new extraction cycle, manual reset thermostat 47 has to be activated by pushing. extension rod 48 inward. Heating element assembly 40 by means of removable plastic nut 42, can be easily assembled and disassembled to and from vessel 60, as explained later. This feature is required when cleaning the interior of vessel 60 or the heating element 28.

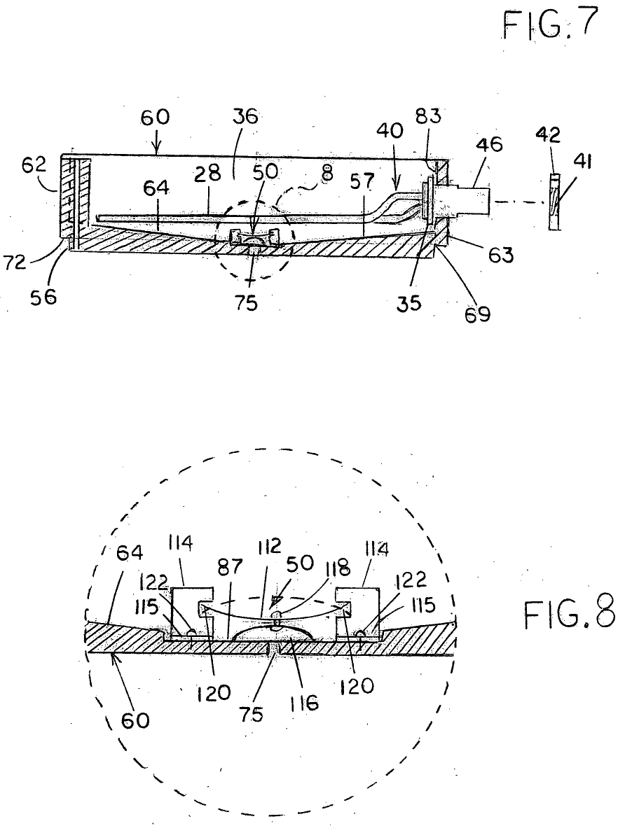

Dispensing vessel 60, as shown in FIG. 5, functions as a hot water measuring and dispensing device that is formed from a cylindrically shaped wall 62, having a molded 90° protruding corner 31. Corner 31 houses a water overflow compartment 33, shown by hidden lines, between corner 31 inner walls and vessel 60 cylindrical shaped outer wall 62. Overflow compartment 33 is connected with the interior space 36 of vessel 60 by means of a rectangular cutout 34. Cutout 34 can be of any geometrical shape. When water is poured into vessel 60 and the water level 38, as shown by the dash dot dash line, reaches the bottom edge 37 of cutout 34, FIG. 9, the right amount of extraction water is in vessel 60 interior space 36. When overfill occurs, the excess water, not shown, will flow from vessel 60 interior space 36 into overflow compartment 33 and can be discarded after the completion of the extraction cycle. Lower portion of wall 62, FIG. 7, is integrally joined to a base 64, and at that point of connection a peripheral step 69 extends about vessel 60. Peripheral step 69 is defined by a first surface 72 and a second surface 56, where each surface is preferably disposed at a 93° angle to the other. The disposed angle between surfaces 72 and 56 is dictated by a circumferencial rim 136 on coffee basket 110, FIG. 16, since vessel 60 is superimposed upon coffee basket 110 during the extraction process. Vessel 60 also includes a centrally located drain orifice 75 located in base 64. Drain orifice 75 is preferably sized so that a water flow of 700 ml./min. is realized. Boiling water entering drain orifice 75 will gravity fall into coffee basket 110 there below. Vessel base 64 has an inner surface 57, FIG. 7, that is sloped towards the drain orifice 75 at a 5° angle in order to facilitate better drainage from vessel 60.

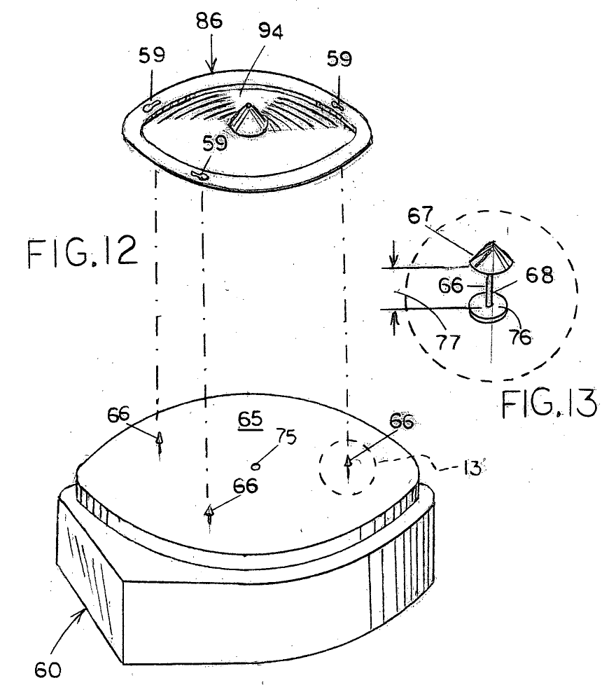

Vessel 60 further includes a diffuser plate 86, FIG. 9, 10, and 11 that has to be assembled to outer bottom surface 65 in the manner as seen in FIG. 12. Diffuser plate 86 is removable for cleaning by the consumer when cleaning is required. The reason for diffuser plate 86 is to distribute extraction water more evenly over the coffee grounds in coffee basket 110 below.

Diffuser plate 86, FIGS. 10 and 11, is centrally located to the outer bottom surface 65 of vessel 60, FIG. 9, and defined area wise to be 65% of vessel 60 outer bottom surface 65 area. Plate 86 is seen to include a center located depression 90, and a hole 91 concentrically arranged within depression 90. Hole 91 in depression 90 is preferably three times smaller in diameter than drain orifice 75. Because hole 91 is three times smaller than orifice 75, depression 90 will fill with water quickly and will start to overflow during the extraction process. The sitting volume of water within the depression 90 will add a slight amount of pressure to the flow of water exiting through hole 91 onto to the coffee grounds that are in coffee basket 110 below. Overflow from depression 90 will spill through the spacing 58, FIG. 9, onto the convex disk shaped area 92 of diffuser plate 86 and trickles over the peripheral outer edge 93 onto the coffee grounds in coffee basket 110 below, thus distributing the extraction water more evenly over the coffee grounds. Convex disk shaped area 92 slopes towards diffuser plate 86 peripheral outer edge 93 at a 5° angle 95. The bottom side 94 of diffuser plate 86 is hollowed out to save material when molded. Diffuser plate 86 has the three identical formed keyhole cut outs 59 in convex disk shaped area 92 that run vertically through the diffuser plate 86 connecting convex disc shaped area 92 to bottom side 94. Keyholes 59 are positioned in a triangular pattern on diffuser plate 86, as shown. The purpose of keyholes 59 is to help to position and attach the diffuser plate 86 to vessel 60 base 64 outer bottom surface 65, as seen in FIG. 12 below. Keyholes 59 are formed into the thicker molded sections 61, as shown in FIG. 11.

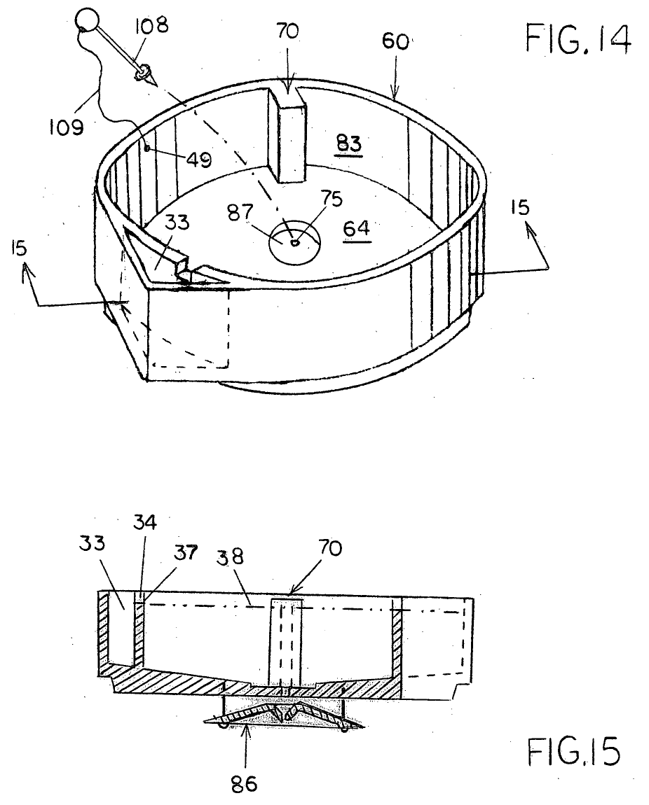

In FIG. 12, vessel 60 base 64 bottom outer surface 65 shows the three stainless steel screw machined or cold header parts 66 that are molded in a triangular pattern into base 64 outer bottom surface 65 as shown. This triangular pattern corresponds exactly with the triangular pattern of keyhole cut outs 59 in diffuser plate 86, as shown in FIG. 10. The function of these parts is to receive diffuser plate 86 when it is assembled to vessel 60 outer bottom surface 65. All three parts are identical and one is shown as a single part 66, in details in the enlarged circle section in FIG. 13. Part 66, has a formed cone shape head 67 that is centrally located on the top of a stem 68. The function of the cone shape head 67 is to guide diffuser plate 86 through said keyholes 59 to bottom outer surface 65 of vessel 60. Head 67 is larger in diameter then the diameter of stem 68 and is also larger in diameter than the narrow width of the slot cutouts 71 of diffuser plate keyholes 59, as seen in FIG. 10. Likewise, head 67 is smaller in diameter than the diffuser plate keyholes 59 that have the large round cutouts 73, shown in FIG. 10. Stem 68 cooperates with diffuser plate 86 keyhole 59 cut outs 71 by having the diameter of stem 68 smaller than keyholes 59 narrow slot cut outs 71, shown in FIG. 10. At the bottom end of stem 68 is a centrally located formed disk 76 that has a larger diameter than the diameter of stem 68. Disk 76 provides a secure fastening way of parts 66 to outer bottom surface 65 of base 64 when plastic material is injected around disks 76 in the molding operation. The free height 77 of stem 68 has to equal to the height 79 of diffuser plate 86, see FIG. 11, and spacing 58 as shown in FIG. 9.

Referring back to the assembling of diffuser plate 86 to bottom 65 of vessel 60, FIG. 12, is explained now. Vessel 60, with bottom outer surface 65 facing up is shown. The molded, into bottom, three machine screw parts 66 are shown also. Diffuser plate 86, with the bottom side 94 facing up, is placed on top of three machine screw parts 66. Diffuser plate 86 is rotated horizontally now until keyhole cutouts 59, FIG. 10, large round cutouts 73 are in alignment with corresponding screw machine parts 66 formed cone type heads 67, FIG. 13. Diffuser plate 86, guided by cone type heads 67, will now drop down against vessel 60 outer bottom surface 65. Diffuser plate 86 is then twisted by hand in anti the clockwise direction until screw machine parts 66 formed cone type heads 67 will cover keyhole 59 narrow slot cutouts 71, FIG. 10. Diffuser plate 86 is now attached to Vessel 60 outer bottom surface 65, and can be picked up, turned right side up, and superimposed to coffee basket 110 ready to receive water for extraction.

In FIG. 14 and 15, the standard extraction unit of the invention that requires the user to manually add boiling water to this slightly modified vessel 60 is shown. With this type of extraction unit, stopper member 108 is inserted into drain hole 75 prior to pouring boiling water into dispensing vessel 60. When the right amount of extraction water is poured into vessel 60, the extraction process is to begin. Stopper 108 is removed from drain orifice 75 and heated water will staret to flow into coffee basket 110 below. A plastic cord 109 is fastened to the interior surface 49 of vessel 60 and stopper 108 in order to prevent losing the stopper. The modifications to standard embodiment vessel 60 are: no heating element assembly 40, and no bimetal disk check-valve assembly 50. The rest of the construction features of modified vessel 60 are the same as the features of preferred embodiment vessel 60.

A check-valve assemblies 70 is shown encircled in FIG. 6 that is molded into the interior surface 83 of wall 62 and base 64. Valve assembly 70 comprises of a valve body 78 having a top surface 84 that is covered by a hinged valve gate 80 that is anchored to top surface 84 by means of a screw 81, or it could be also bonded to surface 84. Valve gate 80 covers the vertically extending passageway 82, shown by hidden lines, that extends entirely through valve body 78 and base 64. The valve gate 80 is formed from any material having elastic qualities so that when the gate is anchored by screw 81, it will function to form a movable flap to cover and open passageway 82, as shown by the arrow. The check valve assembly 70 valve gate 80 is pushed open during the coffee extraction process by entrapped gasses and steam that are formed during the process that will enter through the lower part of passageway 82 and then travel upwardly through valve body 78. Valve gate 80 will close after gasses and steam have escape from extraction unit 10.

The dispensing vessel 60, shown in FIGS. 5 and 7, cylindrical wall 62 has a flat wall segment 63 that has a through hole 85, not shown, punched for receiving heating element assembly 40. Heating element assembly 40 housing 46, with plastic nut 42 removed, is assembled to dispensing vessel 60 by inserting housing 46 through hole 85 from interior space 36 Heating element 28 must be horizontally aligned with base 64 as shown. Plastic nut 42 is then pushed over housing 46 and screwed hand tight to housing 46 matching outside threads. Nut 42 must be screwed tight enough to squeeze rubber washer 35 firmly against vessel 60 interior surface wall 83 to prevent water from leaking out. A detachable electric cord 44 connects heating element assembly 40 to the electric power outlet.

The preferred extraction unit of the present invention utilizes disk-shaped bimetal check-valve assembly 50, FIGS. 7 and 8, that is assembled into the formed indentation 87 around orifices 75 of bottom surface 64 of dispensing vessel 60, shown in FIGS. 5 and 14. Valve assembly 50 prevents heated water from flowing out of vessel 60. Other types of check valves can be used also, providing they function the same way. The preferred check valve assembly 50 comprises of a bimetal disk 112 and the three disk retainer members 114 assembled to surface 64 indentation 87 in a triangular pattern around drain hole 75. For reason of clarity, only two members 114 are shown in FIG. 8. Each retainer member includes a respective slot 120 for receiving therein, the peripheral edge of bimetal disk 112. Further comprising check valve assembly 50 is a half sphere-shaped elastomeric pad 116 attached to the center portion of disk 112 by means of a tab 118 being fractionally pressed into hole 113 (not shown) at the center of member 112. Pad 116 covers drain hole 75 in a first and closed position, as shown in FIG. 8, and opens to the second position, shown in dashed-line form, upon bimetal disk 112 reacting to a predetermined water boiling temperature within vessel 60. When pad 116 is in the open position, heated water flows into drain valve 75 before gravity feeding onto diffuser plate 86 that is mounted under vessel 60 outer bottom surface 65, best seen in FIG. 9. Each of retainer members 114 is attached to base 64 by means of the self drilling screws 122 inserted through respective through holes, not shown, in the mounting tabs 115 that are formed at 90° angel into bottom of each retainer members 114.

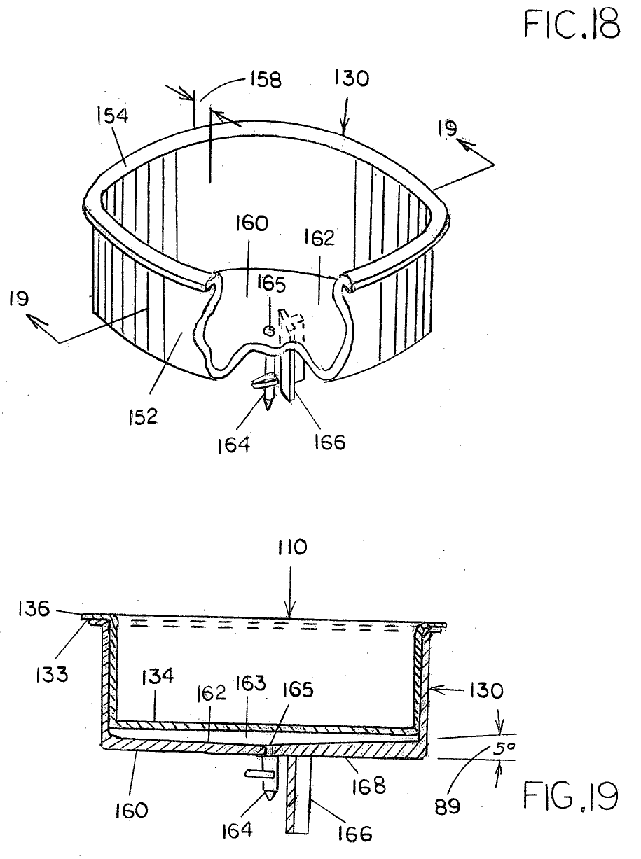

The preferred embodiment of coffee basket 110 is shown in FIGS. 16 and 17. Basket 110 includes the cylindrically formed wall 132 having a lower end and an upper end, where the lower end includes the integrally formed bottom floor 134, which due to its construction is a filtering element of the present invention. The upper end includes outwardly projecting circumferential rim 136 defined by a top surface 137 and a bottom surface 133. Rim 136, in conjunction with vertical height of the wall 132, acts as a stop to control the insertion depth of coffee basket 110 into extraction vessel 130. This relationship is best seen in FIG. 19 which shows the coffee basket 110 as inserted in extraction vessel 130 and where it is seen that bottom floor 134 of coffee basket 110 is disposed just above the uppermost portion of the bottom wall 160 that has a bottom top surface 162 of extraction vessel 130, as seen in FIG. 19. It is seen in FIGS. 18 and 19 also that bottom surface 133 of rim 136 of basket 110 is resting on the planar top edge 154 of the cylindrical side wall 152 of extraction vessel 130. Rim 136 also functions as a C carrying handle for the user. As seen in FIG. 16, bottom floor 134 includes a series of spaced openings 138 that allow the finished coffee extract to flow through. Openings 138 can be formed of any desired shape, although here they are shown to be tear dropped shape. Each of openings 138 are covered with a food-grade plastic or stainless steel 250 micron mesh cloth 139 that is permanently molded into floor 134, thereby forming a filter element that is built-in to coffee basket 110. However, a second embodiment floor 88, seen in FIG. 17, can be used. Floor 88 is removable and is an identical copy of coffee basket 110 floor 134. In this case the coffee basket 110 cylindrical wall 132 would have no bottom 134 and second embodiment floor 88 would be fastened to cylindrical wall 132 bottom edge with self drilling screws through a series of mounting holes 135 that are located and shown around the periphery of floor 88. Depending upon the chosen shape for openings 138, the number of openings should remove at least 75% of floor 134 area and also floor 88 area in order for the extract to properly flow out of coffee basket 110 and into extraction vessel 130 in the extraction process. It has been found that if the filter element is 250 mesh, all 0.004 inch and greater sized ground coffee granules will be removed from the finished extract, while the flavor components, oil droplets, and colloids will pass through.

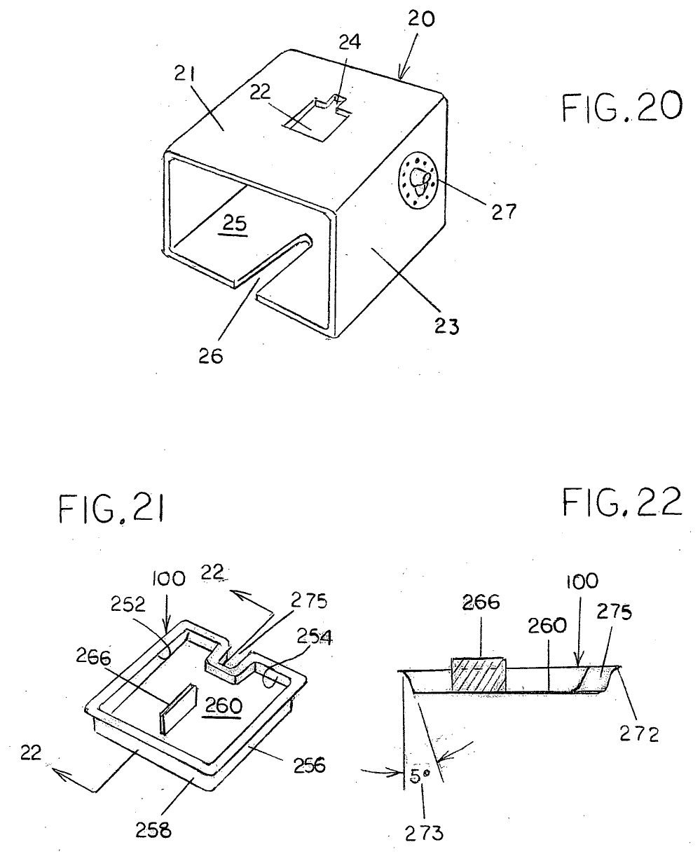

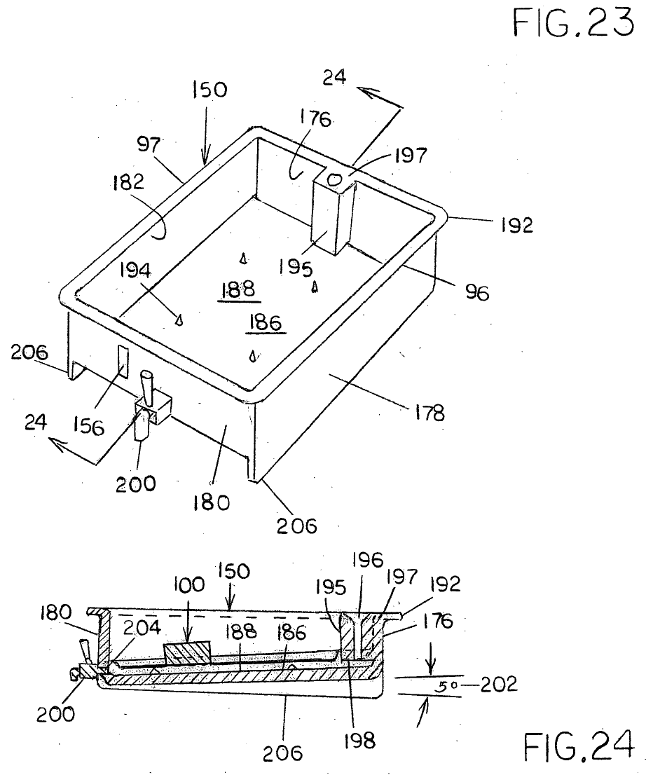

In FIGS. 18 and 19, extraction vessel 130 is presented. Extraction vessel 130 is also formed by cylindrically shaped side wall 152 having planar top edge 154. The lower end of side wall 152 includes integrally connected bottom wall 160 that has bottom top surface 162 which is sloped at a 5° angle 89, FIG. 19, towards the dispensing opening 165 that facilitates coffee extract flow out of extraction vessel 130. Dispensing opening 165 is located in the center of vessel 130 bottom wall 160. Dispensing opening 165 inside is threaded to accept a manually operated spigot 164. The assembling of manually operated spigot 164 into dispensing opening 165 is done by screwing spigot 164 into opening 165. As seen in FIG. 19, there is a spacing 163 that is between surface 162 and bottom floor 134 of coffee basket 110 that will prevent surface 162 from touching bottom floor 134 of coffee basket 110. Spacing 163 is needed to allow the extraction to flow freely towards opening 165. Vessel 130 also includes a stop 166 that is molded into the bottom surface 168 of bottom wall 160. Stop 166 assists with positioning extraction vessel 130 onto the top wall 21 of base 20, as seen in FIG. 20, Stop 166 also helps to position extract storage container 150, as seen in FIG. 2 inside base 20, when extraction is processed. Referring to FIGS. 23 and 24, stop 166 extends downwards past the planar rim 192 of the back wall 176 of storage container 150. When storage container 150 is pushed into base 20, FIG. 2, stop 166 will line up spigot 164 of vessel 130 with the inlet receiver boss 195 and the funnel shaped tube 196 of storage container 150, as best seen in FIG. 24. The side to side positioning of container 150 inside base 20 is simple, the width of storage container 150 with planar rims 96 and 97, corresponds with the inside side to side width of base 20, thus accomplishing the side to side positioning of container 150.

As FIG. 20 shows, base 20 has an opening 22 and an opening 24 formed in top wall 21. Opening 22 accommodates spigot 164, and opening 24 accommodates stop 166 of the extraction vessel 130, FIG. 19, when said extraction vessel is positioned to base 20. A mechanical timer 27, assembled to wall 23 has a bell alarm. The purpose of the timer is to tell the consumer when the extraction cycle is completed. The bottom wall 25 includes a centered slot 26 that extends about halfway through the extent of said wall. Slot 26 provides clearance for spigot 164 and stop 166 of extraction vessel 130 when it is stored inside base 20.

FIGS. 21 and 22 shows float 100 in perspective and cross sectional view. Float 100 is molded of a unitary, yet very thin plastic material. Float 100 is designed to prevent air oxidation and the escape of coffee volatile flavor and aromatic components into atmospheric air when coffee extract is stored in storage container 150, FIG. 23. Although the float is a thin unitary member, it nevertheless defines the side walls, 252, 254, 256, 258, and bottom surface 260. As best seen in FIGS. 21 and 22, the top of each side wall is formed as a continuous peripheral rim 272 that stiffens the float periphery and makes a sharp edge contact along the interior surfaces of the side walls 176, 178, 180, and 182 of extract storage container 150, as seen in FIG. 23. Preferably each of side walls 252, 254, 256, and 258 is provided with a downward slope towards bottom surface 260 at a 5° angle, designated as an angle 273, FIG. 22. Angle 273 compensates for tilting of extract storage container 150, FIG. 24, when it is being carried, and allows float 100 to follow the liquid extract level to the floor 186 of container 150, FIG. 24, without the dimensional clearance change around periphery of float 100 and the interior surfaces of container 150, FIG. 24. Side wall 254 is formed with a notched section 275 that provides clearance for receiving boss 195 of container 150, FIGS. 23 and 24. Float 100 further includes a raised molded boss 266 formed in surface 260. Boss 266 is placed in close proximity to side wall 258. Boss 266 serves two purposes, first to act as a handle to help to raise and lower the float into or out of container 150, and secondly it is a balance weight that compensates for the weight of the extra molding material that is presented by forming notched section 275. The proper weight balance will ensure that the float 100 is maintained in a level position relative to the horizontal on top of any coffee extract that is stored within container 150, FIG. 24.

In FIGS. 23 and 24, coffee extract storage container 150 is shown in perspective and cross sectional views with accompanying float 100, shown in FIGS. 21 and 22. Container 150 has four interconnected walls 176, 178,180 and 182 that are molded to a floor 186. Wall 180 has a glass, or a transparent plastic observation window 156 that is molded, or glued, into wall 180. Window 156 allows the coffee extraction level in the storage container 150 to be seen by the position of float 100 in the storage container 150. The top portion of interconnected walls 176,178,180, and 182 further defining a top edge that is formed as continuous planar rim 192. Rim 192 adds strength to container 150 by stiffening its side walls and further functions as a handle to assist moving the container 150 to another storage location, as will be explained below shortly. Container floor 186 has an interior surface 188 that includes the four identically shaped needlepoint spacers 194. Spacers 194 are disposed in a spaced manner across interior bottom surface 188. The four spacers, as shown, have the function to provide clearance between surface 188 of container 150 and surface 260 of float 100, FIG. 22. The clearance that is provided is equivalent to the vertical height of spacers 194. This minute clearance allows the coffee extract to enter container 150 through inlet receiver boss 195 and flow underneath the float 100, as coffee extract is dispensed from extraction vessel 130, FIG. 19. Inlet receiver boss 195 is provided with internal funnel-shaped tube 196 that has a wider tapered entrance section which guides the flow of coffee extract from the spigot 164 of said extraction vessel 130 into container 150. Preferably, receiver boss 195 is molded to interior surface of wall 176 such that the top face 197 is on the same plain with rim 192, while the bottom face 198 lies above the floor 186 interior surface 188. With bottom face 198 not extending all the way to interior surface 188, it can be appreciated that tube 196 extends from top face 197 to bottom face 198, with the vertical distance between interior surface 188 and bottom face 198 allowing the coffee extract to drain from tube 196 and flow under float 100. Container 150 preferably is provided with a slope such that the floor 186 slopes towards a dispensing spigot 200 at a 5° angle, designated at 202. The container 150 is provided with a hole 204 in wall 180 for anchoring therein spigot 200, and also includes the two identical risers 206 that are molded as extensions to each wall 178 and 182 which function to keep the container level in horizontal plain as it fills with coffee extract.

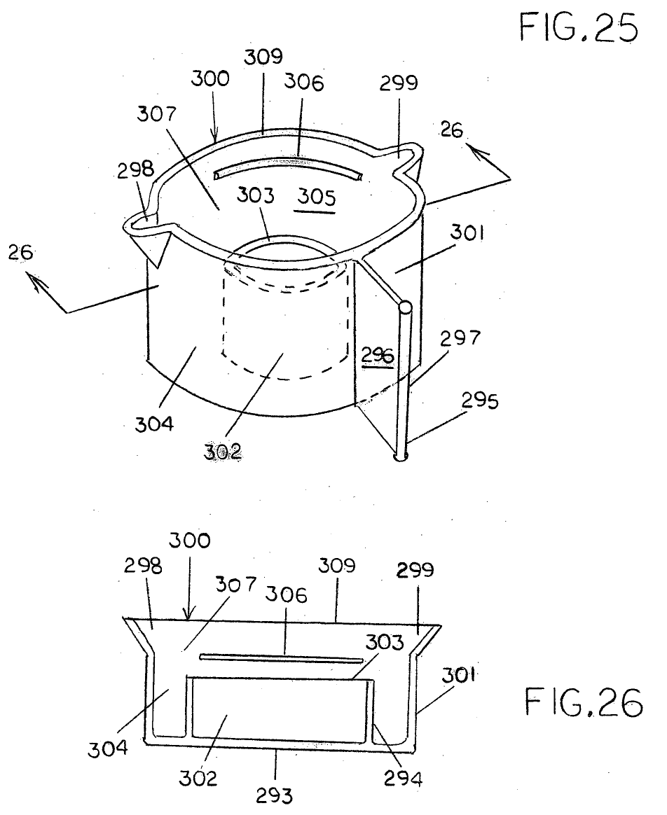

In FIGS. 25 and 26, a measuring device 300 is shown in perspective and cross sectional view. Device 300 is molded plastic and accepts two ounces of coffee extract. Device 300 is designed such that the consumer, with a little practice, can measure out the right amount of coffee extract for a cup of coffee to suit the consumer's taste when extract is drawn from extract storage container 150 through spigot 200, FIG. 23. The preferred shape of measuring device 300 is cylindrical, but can be of any geometrical shape providing it will render the same functions as measuring device 300 does. Measuring device 300 comprises of two cylindrical shaped compartments. An inner compartment 302, shown partially by hidden lines in FIG. 25, and holds one ounce of coffee extract when filled to the top edge planar surface 303 of compartment 302. A main compartment 304 that holds inner compartment 302 and an additional one ounce of coffee extract in the interior 307 of main compartment 304 when filled to a molded line marker 306. Molded line marker 306 is molded to main compartment cylindrical wall 305 as shown. Inner compartment 302 top planar surface 303 is lower than the top edge planar surface 309 of main compartment 304. Inner compartment 302 height is 50% of the inner vertical height of main compartment 304. The reasons for compartments 302, 304, and the height difference is explained now. The normal amount of coffee extract for a regular eight ounce cup of coffee is one ounce. When the consumer draws coffee extract from the extract storage container 150, FIG. 23, into any other type of small one ounce measuring devices, there is tendency to over fill the measuring device and spill some extract to the kitchen cabinet counter-top. Measuring device 300 will prevent this. For example: when the consumer needs One ounce of extract for a cup of coffee, hr fills it into compartment 302 first. When overfill occurs, the extra extract will be spilled into compartment interior 307 of main container 304, instead to the kitchen counter top. With little practice with said measuring device 300, if the consumer wants a weaker cup of coffee, inner compartment 302 of measuring device 300 can be filled to about three quarter level or even less. If the consumer wants a stronger cup of coffee, the additional amount of extract needed can be deposited into main compartment 304 interior 307 as overflow from compartment 302 and up to line marker 306 if required. When the consumer wants to fill a carafe with multiple number of drinkable cups of coffee, measuring device 300 can be filled with two ounces of extract that is equivalent to two cups of drinkable coffee and this would make the preparation of drinkable coffee into the carafe a little speedier. Another reason for inner compartment 302 to be lower than the main compartment 304 top edge planar surface 309 is that when pouring one ounces of extract out of compartment 302, the extract, when measuring device 300 is tilted, flows directly into compartment 304 interior 307 and from there it will be poured into a coffee cup drip free by means of the molded spout 298 or 299.

Molded spouts 298 and 299 are opposite to each other, FIGS. 25 and 26, and are on the same plain with top edge planar surface 309 of the cylindrical wall 301. Further, there is a molded protruding handle 297 that is molded to cylindrical wall 301. Handle 297 is centrally located on cylindrical wall 301 at 90° angle in relation to protruding spouts 298, and 299. Handle 297 consists of a rectangular flat section 296 and a molded round bar 295 that is formed to the flat section 296. Bar 295 helps to prevent the fingers from sliding off the flat section 296 when measuring device 300 is used. Measuring device 300 with the two spouts 298, 299, and handle 297, is designed so that a left or a right handed person can use the device 300 comfortably. A right handed person will be pouring extract out of measuring device 300 by using spout 298, whereby a left handed person will use spout 299. The lower portion of cylindrical wall 301 of compartment 304 and the cylindrical wall 294 of compartment 302 are integrally joined to a common bottom 293, thus making it a compact and handy measuring device.

Turning to FIG. 27, the perspective view shows a suggested method for mounting pair of extraction storage containers 150, FIG. 23, that have coffee extract therein, under kitchen cabinets. The reason to use two containers 150 is that one could be used for regular and the other for decaffeinated coffee extract, or for extract made by using two different tasting brands of coffee grounds. If there are more than two taste requirements in the family, the consumer can buy as many container as required. The respective roll formed aluminum or pre-painted steel mounting slides 280 are shown prior to attachment under the cabinets. The appropriate screws, or nuts, bolts and spacers, are not shown. Other types of mounting slides, like two piece side mounting slides can be used as well, however the one piece slide has been found to be the easiest to be assembled under the cabinet. Mounting slides 280 have a formed sections 282 that create a female receptacle for receiving therein, planar rim 192 of the storage container 150, FIG. 23.

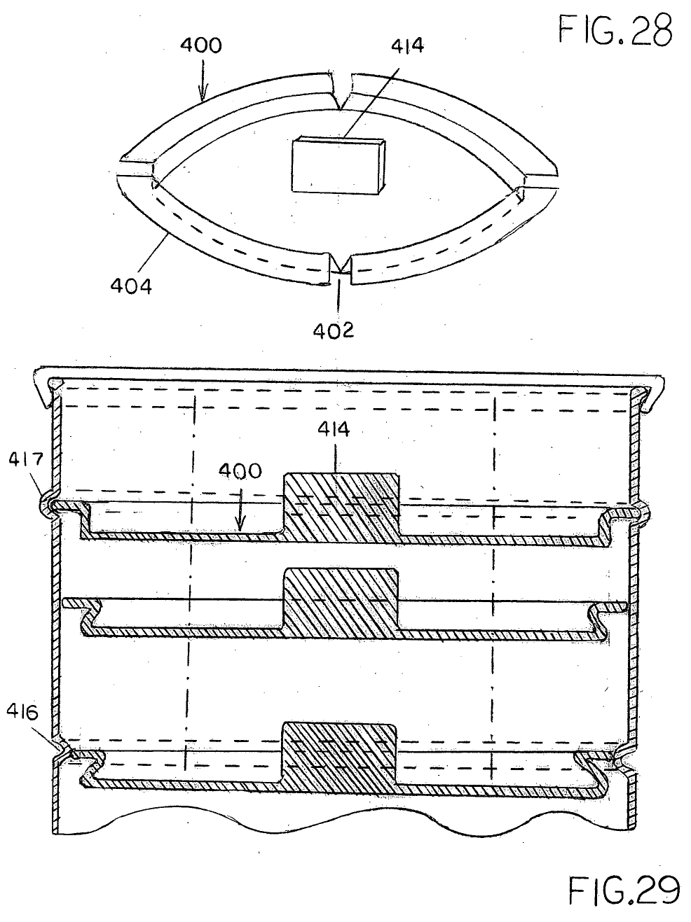

FIGS. 28 and 29, show a molded coffee can lid 400 in perspective and cross sectional views. This particular lid serves the purpose to prevent atmospheric air from reaching the ground coffee contained within either a just-opened or partially emptied can, and prevents coffee flavor and aromatic volatile escaping from coffee grounds into the atmosphere. Lid 400 has four “V’ shaped clearance cutouts 402, around the lid edge periphery 404. Lid edge periphery 404 is “Z” shaped, that allows edge perifery 404 to flex inwardly or outwardly as illustrated in FIG. 29. “V” cut outs 402, close when the lid edges are flexed inwardly, or open when flexed outwardly depending on the inner surface of the purchased coffee can. The flexure allows lid 400 to conform to the interior wall of the coffee can. Typically, it has been found that most commercial metal coffee cans have reinforcements rings around the can that are the concave type rings 416, but lid edge periphery 404 will also handle the convex rings 417. Between the reinforcement rings is usually a smooth surface 418 that does not cause problem. It has been found that by using two lids, the plastic lid that comes with the coffee can, and lid 400, the coffee grounds in the already opened can will stay fresh for months. Further, lid 400 has a molded raised section 414 that is centrally located as shown in FIGS. 28 and 29. Raised section 414 serves as a handle to help insert and remove the lid 400 from the coffee can.

The General Theory and Method of Processing.

Now that the individual components comprising the extraction unit of the invention have been described, the general processing theory and method of forming a concentrated coffee extract will now be described. First of all, the author of the present invention has discovered that it is desirable at least substantially to reduce the free oxygen contained within the water for making the extract, as well as the bacteria and mildew spores contained within the ground coffee, when heated water is soaking the coffee grounds in the steeping process. Because with these components removed, the final coffee extract that is brewed will have extremely long lasting storage and flavor qualities.

One of the theories drawn upon for developing the extraction process of the invention is that water contains undesirable free oxygen. It is known and stated in Siwetz's book of “Coffee Technology,” page 639, that for every liter of 70° F. water there is 6.2 milliliters of saturated free oxygen present. However, when the water is raised to a temperature of 210° F., the maximum free oxygen present is only 0.6 milliliters per liter of water. Therefore, with the present process for making extract, it is desirable to bring the water temperature to boiling point. It is also known that when milk is heated to a temperature of at least 141° F., pasteurization occurs whereby harmful bacteria and mildew spores within milk are killed. However, in 141° F. temperature the pasteurization takes a long time. With these two principals in mind, the present author discovered that when making a coffee extract, a similar pasteurization process can be applied to kill the bacteria and mildew spores in the ground coffee also. It was discovered that when the temperature of the water is maintained at a temperature of 165° F. and above, the coffee extract is also pasteurized as long as that temperature is maintained continuously for ten minutes. Thus, it should be appreciated that with those two features being desired in the process, the extraction vessel 130 and coffee basket 110 were selectively sized such that the amount of exposure to atmospheric air was minimized when hot water measuring and dispensing vessel 60 is superimposed to coffee basket 110 and vessel 130 assembly. The predetermined volume of ground coffee and water would fit into the basket so that only a relatively small, insignificant amount of free space is present at the top of said assembly. This space will fill with coffee foam during the extraction process. Thus, it should be appreciated that with the present invention, very little air space is present in the said assembly during the extraction process, favorably limiting oxidation, loss of flavor and aromatics component into the air.

The present author also discovered that when the ground coffee molecules are exposed to hot water, favorably they release carbon dioxide gas at a rapid rate as well as some coffee volatiles. However, it was also discovered that the main components which affect coffee flavor are not much activated until being continuously exposed to water in the temperature range from 165° F. to 210° F., for at least 6 to 10 minutes of exposure. The dispensing vessel 60 was designed with a water dispensing drain hole 75 that was sized to allow hot water enter coffee basket 110 at a preferred rate of 700 ml. per minute. This relatively slow water dispensing rate importantly serves several functions. First, it allows the heated extraction water to slowly saturate the ground coffee molecules, thereby releasing most of the entrapped carbon dioxide gas before the extraction process actually occurs. Secondly, the slow saturation of the coffee grounds ensures that a very high percentage of coffee grounds become saturated and heavy, making them less likely to float on top of the hot extraction water. If the grounds are not adequately saturated, they tend to float, requiring additional space volume in the vessel. Third, by slowly saturating, the incidence foaming within the vessel is also reduced. It has been discovered that the ideal water dispensing rate of 700 milliliters per minute maximizes each of the above-mentioned features. However, if the water dispensing rate was at least 400 milliliters per minute, a high quality coffee extract is still produced but now the process would take a much longer time, compared to the 700 milliliter flow rate. It has been found that the highest dispensing rate is about 800 milliliters per minute, otherwise too much foaming occurs within the dispensing vessel and coffee basket.

It was also found that the dispensing vessel outer wall and coffee basket outer wall should be designed to have a combined wall thickness that can retain the heat of the hot water within those compartments for at least 15 minutes such that the water temperature does not fall below 165° F. or else pasteurization may be jeopardized. Based on the tests of this author, a combined wall thickness, 1/4 inch of plastic material is adequate. Ideally, the water temperature entering the extraction vessel should be between 195 to 210° F. in order to reduce the amount of saturated free oxygen in the water. Further, at this initial water temperature, as the water cools after being dispensed over the ground coffee, it remains well over 165° F. during the entire coffee extraction process. The 165° F. temperature guarantees that all bacteria and mildew spores in the ground coffee are killed, otherwise they would be transferred into the coffee extract that would reduce the storage life of the coffee extract. Maintaining at least a 165° F. temperature is also important to help accelerate the transfer of favorable coffee solubles, oils and colloids into the extraction water. Through experimentation, this author has discovered that a well-rounded soluble coffee extraction can be made with the above flow rates and temperatures in mind and the coffee to water ratio of 1:4 to 1:7 by weight. However, it was found that the ideal ratio is 1 to 5.4 by weight which produces a soluble percentage in the extract of 4.5 to 5.6 percent, depending on the quality of the ground coffee used. It has also been discovered that once processed, the extraction filtering system must be properly sized to perform at least two functions. First, it must prevent 0.004 inch coffee grounds and larger from entering the coffee extract, but simultaneously allowing the favorable coffee solubles, oil droplets, and coffee colloids to pass through. The best filter element, for gravity feed dispensing, according to the tests of this author, was found to be 250 mesh filter cloth with the present gravity fed dispensing unit. Forced dispensing like using vacuum, a pump or a press tend to clog up the filtering system. By using a gravity feed dispensing system, the coffee extraction yield will be between 70 to 75 percent, depending on the type of coffee grounds being used. This necessarily means that 25 to 30 percent of the starting extraction water is retained in the ground coffee itself. However, the 70% to 75% yield has been found to produce more cups of coffee per pound than one could accomplish by brewing coffee with the regular drip or percolator type coffee makers. Attempts to recover the potentially available (25% to 30%) coffee extract from the wet coffee grounds has been found not to be economically feasible at present ground coffee prices.

Finally, the quality of the extracted coffee produced by this process was found to be affected by the oxidation and loss of coffee flavor and aromatic components that occurs with the ground coffee that is purchased in metal cans. After opening the can repeatedly, it was found that atmospheric air within the can greatly affects the quality of the coffee prior to beginning the extraction process. Therefore, a uniquely designed, molded plastic coffee can lid is to be utilized as part of the present invention so that when the store-provided lid and the one of this unit is utilized, the flavor and aromatic deterioration of the coffee grounds is substantially reduced. Also, a uniquely designed coffee extract measuring device was designed to help the extract user to measure out the right amount of coffee extract to suit the individual's taste and to prevent spilling of coffee extract onto the kitchen counter top when drawing coffee extract from the coffee extract storage container.

The basic coffee extraction process will now be described. Extraction vessel 130 is placed on top of the base 20. A predetermined amount of ground coffee is placed into coffee basket 110 and the basket is then placed into extraction vessel 130. The preferred ground coffee to water ratio is 1 to 5.4 by weight. When ground coffee from metal cans is used, coffee can lid 400 of the present invention is placed on top of the unused portion of ground coffee in the can. The plastic lid provided with the can, is than used to close the can completely. Next, the extraction storage container 150 with float 100 inserted therein, is pushed inside base 20, as shown in FIG. 2, ready to receive the finished coffee extract. The preferred embodiment vessel 60, has heating element assembly 40 and bimetal disk check valve assembly 50. Dispensing vessel 60 is positioned on top of coffee basket 110. Now cold extraction water poured into vessel 60 should fill the vessel such that the water level reaches the bottom edge 37 of cutout 34, FIG. 9. Detachable electric cord 44 is then attached to heating element 40 and plugged into a 120 volt household current receptacle. The exposed end of extension rod 48, is pushed inward against manual reset thermostat 47 to start the water heating cycle, bringing the extraction water to a boil. The mechanical timer 27 is set for the total required length of water heating, water dispensing, and extraction steeping time.

When the extraction water temperature reaches the desired temperature, 195-212° F. in the bottom zone of vessel 60, the bimetal disc of the check valve assembly 50 opens to allow gravity drainage of the heated water to flow into coffee basket 110. The hot water will then saturate the ground coffee molecules and fill the extraction vessel 130 and the coffee basket 110 with coffee extract that is obtained by predetermined steeping time. Except for a small amount of air space on top of the coffee basket 110 and extraction vessel 130, there is no other atmospheric air present. When mechanical timer 27 bell rings, the extraction cycle is completed and the finished extract can now be dispensed into the extract storage container 150. The consumer must now open manually operated spigot 164 under dispensing vessel 130. The spigot 164 can be reached by hand from inside the base 20. The extract will flow by gravity into container 150. When all the coffee extract is drained out of extraction vessel 130, container 150 can now be stored in the kitchen, especially under the top row of kitchen cabinets. As explained above, the storage container 150 is provided with float 100 which functions to reduce exposure of the coffee extract to the atmosphere, thereby reducing oxidation and preventing most volatile coffee flavor and aromatic components from escaping into the atmosphere. The extract in storage container 150 has a useful shelf life and maintains its flavor for several weeks.

When the standard model unit is used, vessel 60 has no heating element assembly 40 and no bimetal disk check-valve assembly 50. The only difference in operation is that water for extraction must be heated separate from the extraction unit and then poured into the dispensing vessel 60 that has stopper 108 inserted into orifices 75 of vessel 60. When hot water is poured into vessel 60 and reaches the bottom edge 37 of cutout 34, FIG. 15, that will assure that the correct amount of extraction water is in the vessel. The timer 27 is then set for the total required water dispensing, and extraction steeping time. Next the stopper 108 is removed from orifice 75 and water will starts to flow into the coffee basket 110 below. All further steps in the process are the same to those described above with the preferred embodiment.

The greatest advantage the present invention provides to a consumer is the ability to make a cup of fresh tasting coffee at any time of the day without brewing an entirely new batch. Furthermore, by utilizing a coffee extract in concentrated form, each individual consumer can make a cup of coffee suited for particular tastes. The consumer can make a single cup that is either regular or decaffeinated, weak or strong, rather than making an entire pot only to his liking. It will avoids waste and complaints by other coffee drinkers. Also, since the liquid coffee extract is pasteurized, it does not require refrigeration and can remain fresh for several months if it is stored in completely closed containers. It also means that extract processing has to be performed once or twice a month in most households, depending on consumption levels. Also, valuable cabinet counter top space, normally occupied by a regular coffee maker every day, is freed for other uses, because the extraction unit can be stored in a cabinet or pantry most of the time Since the extraction unit of the present invention is relatively compact, it hardly requires much space. When in use or when being stored, typically, it requires less than one cubic foot of space when stacked in the storage mode as shown in FIG. 1. In the processing mode, it has a 12 by 16 inch footprint.

While the apparatus and methods herein disclosed form a preferred embodiment of this invention, it will be understood that this invention is not so limited, and changes can be made without departing from the scope and spirit of this invention, which is defined in the appended claims.

1. A coffee extraction unit for making a batch of concentrated coffee extract, comprising:
Means for heating a predetermined volume of water used in making the coffee extract;
A dispensing vessel for heating said predetermined volume of water to a temperature range between 165-210° F., said dispensing vessel having a drain orifice and a means for valving said orifice, whereby when said valving means is in an open position, said heated water is allowed to drain through said orifice, which said orifice is sized to allow a rate of flow between 400 and 800 milliliters per minute;
A heating element assembly for bringing water to boil in said dispensing vessel
A coffee basket for receiving a predetermined volume of ground coffee therein, said dispensing vessel superimposed on top of said coffee basket such that heated water from said dispensing vessel is received into said basket to saturate said coffee grounds, said coffee basket having at least one bottom opening to pass the heated water through said basket;
An extraction vessel for producing the coffee extract therein, said extraction vessel constructed to receive said coffee basket therein such that heated water passed through said coffee basket is retained within said extraction vessel, whereby said saturated coffee grounds within said coffee basket are allowed to steep within said extraction vessel for a predetermined period of time, thereby producing a concentrated coffee extract within a relatively oxygen-free closed environment that maintains the escape of volatile coffee flavor and aromatic components and means for filtering the concentrated coffee extract.

2. The coffee extraction unit of claim 1, wherein said predetermined period of steeping time is 6 to 10 minutes.

3. The coffee extraction unit of claim 1, further including a removable storage vessel for receiving filtered coffee extract therein, said storage vessel having a movable float in the form of a lid for protecting said filtered extract from the atmosphere so as to prevent oxidation and escape of volatile coffee flavor and aromatic components from said extract, thereby prolonging coffee extract flavor and shelf life.

4. The coffee extraction unit of claim 1, wherein said filtering means traverses said at least one bottom opening of said coffee basket.

5. The coffee extraction unit of claim 4, wherein said filtering means is integrally formed into a bottom floor of said coffee basket, thereby covering said at least one bottom opening of said coffee basket.

6. The coffee extraction unit of claim 4, wherein said filtering means is comprised of a removable filter ring that is in resting contact on the bottom floor of said coffee basket, thereby covering said at least one bottom opening of said coffee basket.

7. The coffee extraction unit of claim 1, wherein said dispensing vessel further includes a check valve assembly formed into a base of said vessel, check valve assembly comprised of a valve body having a top surface and a vertical oriented passageway extending through said valve body and said base of said dispensing vessel, said passageway covered by a hinged valve gate that operates between a closed and open position, said gate normally closed to prevent atmospheric air from entering said passageway, said hinged valve gate opening to allow gasses and steam created in said extraction vessel during the extraction process to exit through said passageway.

8. A process for making a concentrated coffee extract, comprising the steps of:
Placing a predetermined volume of ground coffee into a provided basket having a bottom opening therein;
Placing said basket into a provided extraction vessel, and then adding a predetermined volume of heated water at a controlled rate of flow to said basket, so as to saturate said coffee grounds;
Enclosing said vessel from the atmosphere;
Steeping said saturated coffee grounds for a predetermined period of time within said extraction vessel, thereby producing said coffee extract.

9. The process of claim 8, wherein said predetermined volumes of coffee and water form a ratio, said ratio being between 1:4 and 1:7 by weight.

10. The process of claim 8, wherein said flow rate of said water is between 400-800 milliliters per minute.

11. The process of claim 1, wherein said predetermined temperature is between 165-210° F.

12. The process of claim 11, wherein said water and coffee grounds undergo a form of pasteurization, whereby any bacteria and mildew spores are killed.

13. The process of claim 8, wherein said predetermined period of steeping time is between 6 to 10 minutes.

14. The process of claim 8, wherein said step of steeping releases carbon dioxide gas retained within said coffee grounds into the atmosphere, and flavor enhancing colloids and oils within said coffee grounds into extraction water.

15. The process of claim 8, wherein the step of enclosing said coffee basket, extraction vessel by superimposing said dispensing vessel to said coffee basket to cover the vessel so as to eliminate exposure to atmospheric air.

16. The process of claim 1, further comprising the step of providing a dispensing vessel for receiving said heated water therein prior to said water being dispensed into said coffee basket, said dispensing vessel provided with a check valve assembly that opens to allow the heated water to flow into said basket at said predetermined rate of flow.

17. The process of claim 16, wherein said check valve assembly is comprised of a bimetal disk member having an elastomeric pad attached to said disk member and at least two valve retainer members for holding said disk member, each retainer member attached to a base of said dispensing vessel and disposed about a centrally located drain hole formed in the base of said dispensing vessel.

18. The process of claim 8, further comprising the step of providing a filtering means to filter said coffee extract.

19. The process of claim 8, wherein the filtering means is provided within said basket and is integrally formed as a part of a bottom floor thereof.

20. The process of claim 18, wherein the filtering means is a separate member inserted into said basket so as to rest on the bottom floor thereof.

21. The process of claim 8, further including the step of draining the coffee extract from the extraction vessel into a storage container, said storage container provided with a float therein for reducing exposure of said coffee extract to the atmosphere.

22. The coffee extraction unit of claim 1 further includes a diffuser plate attached to the bottom floor of said dispensing vessel, said diffuser plate functioning to uniformly dispense said heated water over said coffee grounds.
